(19) United States
(12) Patent Application Publication
(10) Pub. No.: US 2014/0310160 A1
(43) Pub. Date: Oct. 16, 2014

(54) Alert System with Multiple Transaction Indicators

(71) Applicants: Pawan Kumar, San Ramon, CA (US); Mark Allen Nelsen, Oakland, CA (US); Todd McGregor, Danville, CA (US)

(72) Inventors: Pawan Kumar, San Ramon, CA (US); Mark Allen Nelsen, Oakland, CA (US); Todd McGregor, Danville, CA (US)

(21) Appl. No.: 14/216,843

(22) Filed: Mar. 17, 2014

Related U.S. Application Data
(60) Provisional application No. 61/810,940, filed on Apr. 11, 2013.

(51) Int. Cl. G06Q 20/40; H04W 4/14

(52) U.S. Cl. CPC G06Q 20/4016; H04W 4/14
USPC 705/39

(57) ABSTRACT

A user may receive an alert notification message on a mobile device for any high risk transaction along with a set of recent transactions conducted on an account associated with the user. The user may be able to respond back by either accepting or rejecting the transaction using an application on the mobile device. In one embodiment, for a rejected transaction, a plurality of options may be presented to the user's mobile device for the user to select a reason for rejecting a transaction. An issuer associated with the payment account used for the transaction may receive the user's response and accordingly take appropriate actions on the account.

### CROSS-REFERENCES TO RELATED APPLICATIONS

This application is a non-provisional of and claims the benefit of U.S. Provisional Patent Application No. 61/810,940 filed on Apr. 11, 2013, which is herein incorporated by reference in its entirety for all purposes.

### BACKGROUND

Transaction alert systems and methods are known. In a transaction alert system, a payment transaction is conducted between a merchant and a holder of a credit or debit card. After the transaction is conducted, the holder may receive an alert message on his or her mobile phone. The alert may be in the form of an SMS message. The transaction alert may provide information such as the amount of the transaction as well as the merchant which conducted the transaction with the user.

While such alerts are useful, a number of improvements can be made. For example, in the conventional alert system, the alert message only provides information about the current transaction. If the user receives a large number of alerts (e.g., when the user receives transactions alerts for transactions conducted by all family members on a master account), it may be difficult for the user to identify the current transaction as being fraudulent. As an example, an alert message with information about an isolated charge for gasoline at a new gas station in the user's home town may be fraudulent, but the user may not notice this by only viewing information about the current transaction. Thus, improved transaction alert systems that can provide better fraud detection and identification are needed.

Embodiments of the invention address this and other problems.

### BRIEF SUMMARY

Embodiments of the present invention allow issuers and account holders to participate in a targeted high risk alert system via a payment processing network. In one embodiment, a user may receive an alert notification message on a mobile device for any high risk transaction along with set of recent transactions conducted on an account associated with the user. The user may be able to respond back by either accepting or rejecting the transaction, while also providing an indication as to whether any of the transactions in the set of recent transactions are potentially fraudulent, using an application on the mobile device. In some embodiments, for a rejected transaction, a plurality of options may be presented to the user's mobile device for the user to select a reason for rejecting a transaction. In one embodiment of the invention, an issuer associated with the payment account used for the transaction may receive the user's response and can take appropriate action on the account.

One embodiment of the invention is directed to a method for receiving transaction data for a transaction associated with a payment account of a user. The method also comprises generating, by the server computer, an alert notification message, and initiating sending the alert notification message including information about a plurality of transactions comprising the transaction and a set of prior transactions to a mobile device. The set of prior transactions in the alert notification message may be any suitable number. For example, the set may be less than 10, 5, or 3 prior transactions.

Another embodiment of the invention is directed to a server computer comprising a processor and a computer readable medium. The computer readable medium comprise code, executable by the processor, for implementing a method. The method comprises receiving transaction data for a transaction associated with a payment account of a user. The method also includes generating an alert notification message, and initiating sending the alert notification message including information about the transaction and a set of prior transactions to a mobile device.

Another embodiment of the invention is directed to a method comprising receiving, from a server computer and by a mobile device operated by a user, an alert notification message. The alert notification message comprises information about a plurality of transactions including a current transaction being conducted and a set of past transactions that were previously conducted using an account associated with the user. The method also comprises generating and sending, by the mobile device and to the server computer, an alert response message. The alert response message comprises data indicating whether one or more of the plurality of transactions is authentic or not authentic.

Another embodiment of the invention is directed to a mobile device comprising a processor and a computer readable medium coupled to the processor. The computer readable medium comprises code, executable by the processor, to perform a method. The method comprises receiving, from a server computer and by a mobile device operated by a user, an alert notification message. The alert notification message comprises information about a plurality of transactions including a current transaction being conducted and a set of past transactions that were previously conducted using an account associated with the user. The method also comprises generating and sending, by the mobile device and to the server computer, an alert response message. The alert response message comprises data indicating whether one or more of the plurality of transactions is authentic or not authentic.

These and other embodiments of the invention are described in further detail below.

### BRIEF DESCRIPTION OF THE DRAWINGS

FIG. 1 illustrates a system in one embodiment of the invention.

FIG. 2 illustrates at least some components of a server computer for implementing a high risk alert system in one embodiment of the invention.

FIG. 3 illustrates at least some of the elements of an exemplary mobile device in accordance with embodiments of the invention.

FIG. 4 shows a flowchart illustrating a method according to an embodiment of the invention.

FIGS. 5A-5B illustrate exemplary alert messages received on a mobile device.

FIG. 6 illustrates a block diagram of a computer apparatus.

### DETAILED DESCRIPTION

In one embodiment of the invention, a user may receive an alert notification message on a mobile device for any high risk transaction along with a set of prior transactions conducted on an account associated with the user. The set of prior transactions in the alert notification message may be any suitable number. For example, the set may be less than 10, 5, or 3 prior transactions (but greater than or equal to one transaction). The transactions in the set of transactions may be those transactions that directly preceded the current transaction. The user may be able to respond back by either accepting or rejecting the current transaction using an application on the mobile device. In one embodiment, for a rejected transaction, a plurality of options may be presented to the user's mobile device for the user to select a reason for rejecting a transaction. In one embodiment of the invention, an issuer associated with the payment account used for the transaction or a server computer in a payment processing network may receive the response from the user and accordingly take action on the account. Thus, embodiments of the invention provide an active communication session between the user and the issuer, which provides improved fraud detection.

Embodiments have a number of advantages. For example, by providing a user with information about the current transaction that is being conducted, along with a set of past recent transactions, the user is better able to identify patterns of potential fraud, thus preventing unauthorized transactions. As an illustration of this, as noted above, as an example, a user may receive an alert message with information about an isolated charge for gasoline at a new gas station in the user's home town on the user's mobile device. This transaction may in fact be fraudulent, but the user may not notice this by only viewing information about the current transaction. For instance, since the user may see many gasoline purchase transactions (e.g., from various members of his or her family), it may not occur to the user that the transaction is potentially fraudulent. If, however, information about the gasoline purchase at the new location and information about the past four transactions at other unknown locations are received in the same alert message, then the user may determine that it is unusual that five transactions have been conducted at locations that the user is not familiar with. This may inform the user that the payment account has been compromised. Thus, information about each transaction, when viewed in isolation, may be insufficient to indicate potential fraud to the user, but collective information about a number of transactions may indicate potential fraud to the user.

Also, in some embodiments of the invention, the alert message is generated and sent only if a transaction meets a fraud threshold. The account holder may want to only receive alert messages if a transaction meets a fraud threshold, because the account holder may otherwise receive too many transaction alert messages. If this option is desired by the account holder, then it is desirable to receive a list of recently conducted transactions because the prior transactions may in fact be fraudulent even though a fraud detection module may not have identified them as fraudulent. For example, a first transaction conducted on an account at a first electronics store and a second transaction at a second electronics store may not be determined to be fraudulent transactions at the time that they are conducted. However, if a third consecutive transaction is conducted on the account at a third electronics store, then the third transaction may be determined to be potentially fraudulent by the fraud detection module in view of the two prior transactions. That is, it is highly unlikely that a legitimate consumer would shop at the three different electronics stores consecutively. In embodiments of the invention, an alert may be sent to the holder of the account listing the third transaction along with the first and second transactions. This allows the user to inform the issuer or a payment processing network that the first two transactions were fraudulent, even though they were not identified as fraudulent at the time that they were conducted.

Further, embodiments of the invention allow the user to respond and provide information about whether each or the transactions shown in the alert message are potentially fraudulent or not. By providing this feature, embodiments of the invention may provide the issuer of the potentially compromised account with more timely information about which transactions are fraudulent. Without this feature, an issuer may have to contact the user separately to determine which of the past transactions conducted by the user are fraudulent.

Such information may also be used to potentially apprehend unauthorized users of the account. For instance, if the user can identify which of a plurality of transactions are potentially fraudulent, then this information can be used to potentially identify the location of the person that is using the account in fraudulent manner. For instance, transactions that are indicated as being fraudulent may be used to identify the fraudster's path of travel and this information may be relayed to law enforcement officials in real time to potentially apprehend potential fraudsters.

I. Systems, Computers and Devices

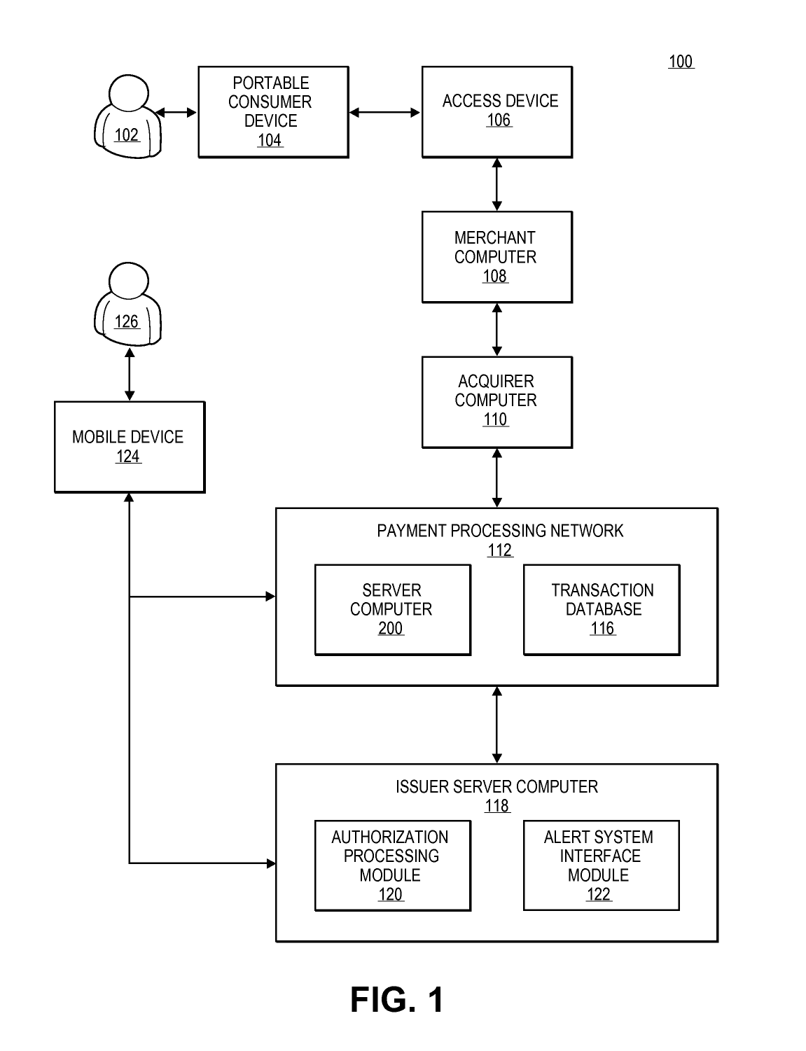

FIG. 1 illustrates a system 100 according to one embodiment of the invention. A user 102 may use a portable consumer device 104 to interact with an access device 106. The access device 106 is in communication with a merchant computer 108. The access device 106 and the merchant computer 108 may be operated by a single merchant in some cases. The merchant computer 108 may be in communication with an acquirer computer 110 and a payment processing network 112. The payment processing network 112 may be in communication with an issuer server computer 118.

In embodiments of the invention, the user 102 may conduct a transaction using the portable consumer device (e.g., a payment card) 104 and the access device (e.g., a POS terminal) 106. The user 102 may be an authorized or a non-authorized user of the payment account used for the transaction. In some embodiments, phones or virtual accounts may be used to conduct transactions instead of a payment card.

The access device 106 or the merchant computer 108 may be configured to generate an authorization request message and forward it to the acquirer computer 110. The authorization request message may include transaction details (e.g., a merchandise description, a transaction amount, a date and time of transaction, a quantity, a merchant identifier, etc.), payment details (a consumer identifier, a payment account number, an expiration date, etc.) and any other suitable information related to the transaction.

An access device may include any suitable device for communicating with a merchant computer or payment processing network. An access device may generally be located in any suitable location, such as at the location of a merchant. An access device may be in any suitable form. Some examples of access devices include POS devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a portable consumer device and/or a user mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a portable consumer device and/or mobile device.

The acquirer computer 110 can include a computer operated by an acquirer. The acquirer may be an entity (e.g., a bank) that has a business relationship with the particular merchant. The acquirer computer 110 may route the authorization request for the transaction to the issuer server computer 118 via the payment processing network 112.

The payment processing network 112 may include data processing subsystems, networks, and operations used to support and deliver authorization services, exception file services, and clearing and settlement services. An example of payment processing network 112 includes VisaNet®, operated by Visa®. The payment processing network 112 may include wired or wireless network, including the internet. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The issuer server computer 118 may be associated with a bank (e.g., a bank computer) that may have issued the portable consumer device 104 or the account number (or other identifier) used for the transaction.

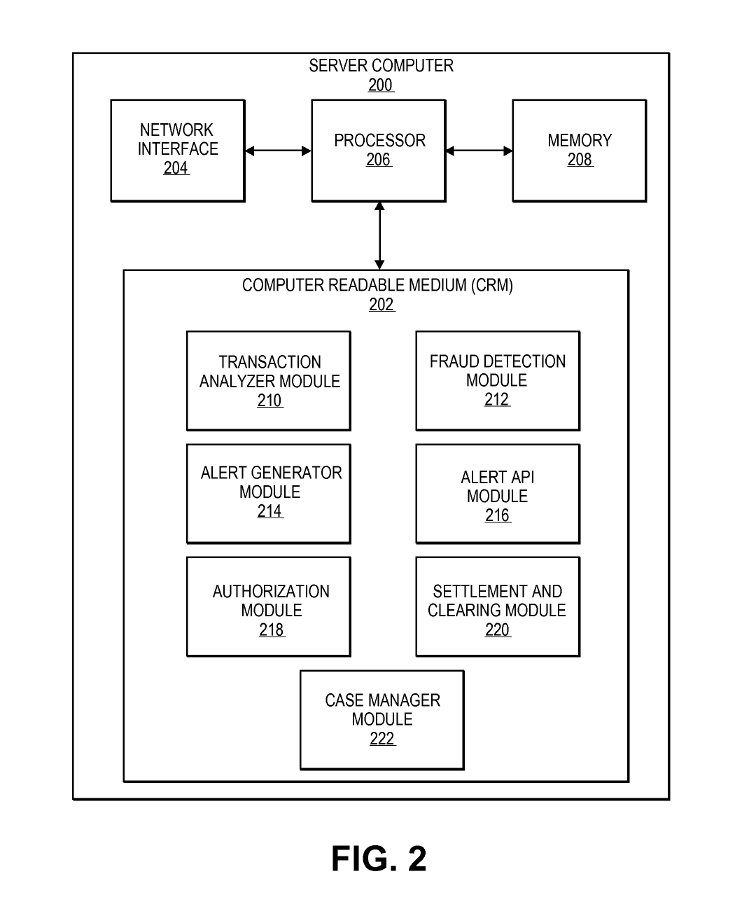

FIG. 2 illustrates at least some components of a server computer 200 for implementing a system according to an embodiment of the invention.

The server computer 200 may comprise a network interface 204, which may be configured to interface with other entities, such as, the acquirer computer 110, and the access device 106, etc. for the exchange of data and information (e.g., transaction and authorization related data) using various communications networks. It may also include a memory 208 may be coupled to a processor 206 internally or externally (e.g., cloud based data storage) and may comprise any combination of volatile and/or non-volatile memory such as, for example, buffer memory, RAM, DRAM, ROM, flash, or any other suitable memory device.

The processor 206 or processing elements may be configured to execute instructions or code in order to implement methods, processes or operations. The server computer 200 may also include a computer readable medium (CRM) 202, which may also be in the form of a memory, and may comprise code, executable by the processor 206 for implementing methods described herein. For example, the computer readable medium may comprise code, executable by the processor, for implementing a method comprising receiving transaction data for a transaction associated with a payment account of a user, determining, by a server computer, if the transaction is a high risk transaction, generating, by the server computer, an alert notification message if the transaction is a high risk transaction, and initiating sending the alert notification message including information about the transaction and a set of prior transactions to a mobile device.

The CRM 202 may also comprise computer code for a transaction analyzer module 210, a fraud detection module 212, an alert generator module 214, an alert API (Application Programming Interface) module 216, an authorization module 218 and a settlement and clearing module 220.

The transaction analyzer module 210 may be configured to receive transaction data for a transaction and analyze the transaction data to determine if the transaction is a legitimate transaction. The transaction data may include one or more of a transaction amount, an account identifier (e.g., primary account number, account token, etc.), a product description, a product category, a merchant identifier, a merchant location, a consumer identifier (e.g., name, address, phone number, etc.), a quantity, and any such relevant information related to the transaction.

The fraud detection module 212 may be configured to determine if the transaction is fraudulent or not based on the analysis of the transaction data and a transaction history associated with the account used for the transaction. The transaction history may be stored in the transaction database 116 that may be externally or internally coupled to the payment processing network 112. In some embodiments, the fraud detection module 212 may perform a fraud analysis based on certain fraud rules that may be stored in the transaction database 116 or any other database coupled to the server computer 200. For example, a fraud rule may specify that if a transaction amount is over $500 and the shipping address is out of state then the transaction may be fraudulent.

If the transaction is determined to be fraudulent by the fraud detection module 212, the alert generator module 214 may generate an alert notification message. The alert notification message may include transaction details for a current transaction and a set of recent transactions. In one embodiment, the transaction details for last few transactions may be stored in the transaction database 116. The transaction details may include a date and time of the transaction, a transaction amount, a merchant identifier, a merchant name or any such suitable information. In one embodiment, the alert notification message is only generated if the user is registered in the high risk alert system. The alert notification message may be sent to the user 126 and the issuer server computer 118 to notify them for a potential fraud.

The alert API module 216 may present to the mobile device 124 associated with the user 126, a user interface with options to accept or reject a transaction as well options to select a reason for rejecting a particular transaction as part of an alert message. The alert API module 216 further enables communication between the mobile device 124 and the issuer server computer 118. For example, the alert response message is based on the options selected by the user 126 and is transmitted to the issuer server computer 118. The alert API module 216 may also be configured to enable the user 126 to enroll or register in the high risk alert system using the mobile device 124 or any other electronic device associated with the user 126.

An authorization module 218 may be configured to process the authorization request message received from the acquirer computer 110 and determine the appropriate destination for the authorization request message. The settlement and clearing module 220 may be configured to perform settlement and clearing of the transactions.

The case manager module 222 may be an interface between the issuer, the user, and the authorization module in the server computer 200. It can be used to coordinate communication between the mobile device, a payment processing network and the issuer in the alert process.

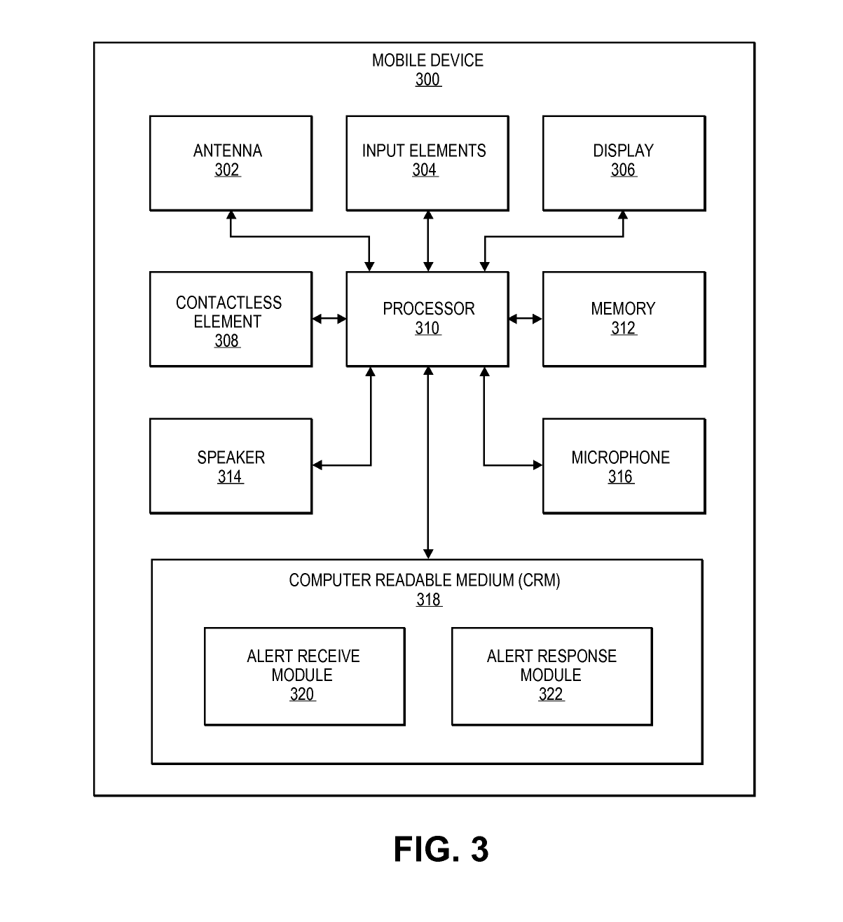

FIG. 3 illustrates at least some of the elements of the exemplary mobile device 124 in accordance with embodiments of the invention.

The mobile device 124 may be a mobile phone, a tablet, a PDA, a laptop or any such electronic device capable of communicating and transferring data or control instructions via a wireless network (e.g., cellular network, internet, etc.) and short range communications. The mobile device 124 may include a processor 310 (e.g., a microprocessor) for processing the functions of a mobile device (e.g., a phone) and a display 306 to allow a user to see messages (e.g., alert messages), phone numbers, images, and other information. The mobile device 124 may further include input elements 304 to allow the user to input information into the device (e.g., using a keypad, touch screen, mouse, etc.), a speaker 314 to allow the user hear voice communication, music, etc., and a microphone 316 to allow the user transmit her voice through the device. The mobile device 124 may also include an antenna 302 for wireless data transfer.

The mobile device 124 may be a notification device to receive alert messages, a portable consumer device that may be used to make payments, or a communication device to allow a user to log on to a website to enroll in an alert system, etc. The exemplary mobile device 300 may comprise a computer readable medium (CRM) 318 comprising code executable by the processor 310 for implementing methods using embodiments of the invention. The computer readable medium 318 may be in the form of a memory that stores data and could be internal to the device or hosted remotely (i.e., cloud) and accessed wirelessly by the device. The contactless element 308 may be capable of transmitting and receiving wireless data or instructions using a short range wireless communications capability. The memory 312 may be coupled to the processor 310 internally or externally (e.g., cloud based data storage) and may comprise any combination of volatile and/or non-volatile memory such as, for example, buffer memory, RAM, DRAM, ROM, flash, or any other suitable memory device. The computer readable medium 310 may also store code for an alert receive module 230 and an alert response module 322.

II. Methods

One embodiment of the invention is directed to a method for receiving transaction data for a transaction associated with a payment account of a user. The method also comprises generating, by the server computer, an alert notification message, and initiating sending the alert notification message including information about a plurality of transactions comprising the transaction and a set of prior transactions to a mobile device. The set of prior transactions in the alert notification message may be any suitable number. For example, the set may be less than 10, 5, or 3 prior transactions.

In embodiments of the invention, “initiating sending an alert notification message” may include sending the alert notification message to a mobile device as well as starting a process for sending the alert notification to the mobile device. In the latter case, an example might be where an instruction is sent to a computer to send an alert notification message to the alert notification device.

Referring to FIG. 1, in embodiments of the invention a user 126 may register one or more payment accounts in a high risk alert system to receive alert notification messages when a high risk transaction is conducted on an account associated with the user 126. The user 126 may register in the alert system using a mobile device 124 or any other electronic device (e.g., a personal computer) via a communication network (not shown). An issuer associated with the issuer server computer 118 may also enroll in the system so that active communication may be established between the user 126 and the issuer server computer 118 and/or the payment processing network 112 if a high risk transaction is detected by the high risk alert system. Note that the high risk alert system can be part of the payment processing network 112, however, in some embodiments, the high risk alert system may be hosted by a third party or the issuer server computer 118.

In some embodiments, the mobile device 124 may enable the user 126 to enroll one or more financial accounts with the high risk alert system using a web application. In one embodiment, the user 126 may be able to set up preferences for generating alert messages, e.g., providing a phone number for receiving the alert message for a particular account. In some embodiments, the user preferences may include another recipient for receiving the alert message.

In some embodiments, the mobile device 124 may be configured to receive alert messages via the antenna 302 when a transaction is conducted on an account associated with the user 126 that may be displayed on the display 306. In some embodiments, the alert message may be received as an email, a text message, a tweet, an SMS or any such suitable communication medium.

In one embodiment, a high risk transaction may involve a transaction amount that seems unusual based on the transaction history associated with the account used for the transaction. For example, if a user spends about $75 for gasoline most of the time, a transaction of $200 at a gas station may be a high risk transaction. In another example, if a user never uses an out of state shipping address, then a shipping address to an out of state location for a transaction amount over $100 may be a risky transaction. In some embodiment, a transaction database 116 may store the transaction history associated with the payment accounts of the users.

A user 102 may conduct a fraudulent transaction (e.g., without the knowledge of or permission from the user 126) using an account associated with the user 126. For example, the user 102 may have access to a payment account number of the user 126. The user 102 may conduct a number of transactions with small amounts (less than $25) before conducting a high amount transaction (e.g., over $500). In some embodiments, an alert message is generated for the high amount transaction and the recent activities including transactions with small amounts are listed in the alert message. In some embodiments, the user 102 and the user 126 may be same if the user 102 is an authorized user.

If the user 126 (account holder) is enrolled in the alert system, the user 126 may receive an alert notification message on his mobile device 124 for a high risk transaction conducted on one or more of his payment accounts. In some embodiments, the alert notification message may also include a quick view of a few recent activities associated with the registered payment accounts of the user (e.g., the last five transactions). The recent activities may or may not be for the same registered payment account.

In some embodiments, after receiving the alert notification message, the user 126 may be prompted to accept or reject the current transaction or one or more recent transactions using an application on the mobile device 124. If the user chooses to reject a transaction, the user may be presented on the mobile device options to choose for a reason for rejection, which helps the alert system determine why the user rejected a certain transaction. For example, the user may choose “lost wallet/card” or “compromised ID” to indicate the reason for rejecting the transaction. In some embodiments, the last few transactions for small amounts may have been temporarily approved but may not have gone through the clearing and settlement process. As an example, in some cases, it may take more than a day for the clearing and settlement process to settle funds between the associated acquirer and the issuer through the payment processing network.

Embodiments of the invention provide an active responsive mechanism between the issuer (or the payment processing network) and the user (e.g., a cardholder) as compared to traditional alert systems where a static alert message is sent to the user and the user often makes a phone call to the associated issuer to get further details. An alert system interface module 122 may receive an alert response message from the mobile device 124 indicating the options selected by the user (e.g., accept or reject, and a reason for rejection). An authorization processing module 120 may take multiple actions accordingly for the compromised payment account. For example, the issuer server computer 118 may perform an auto case close process or may perform a fraud chargeback process.

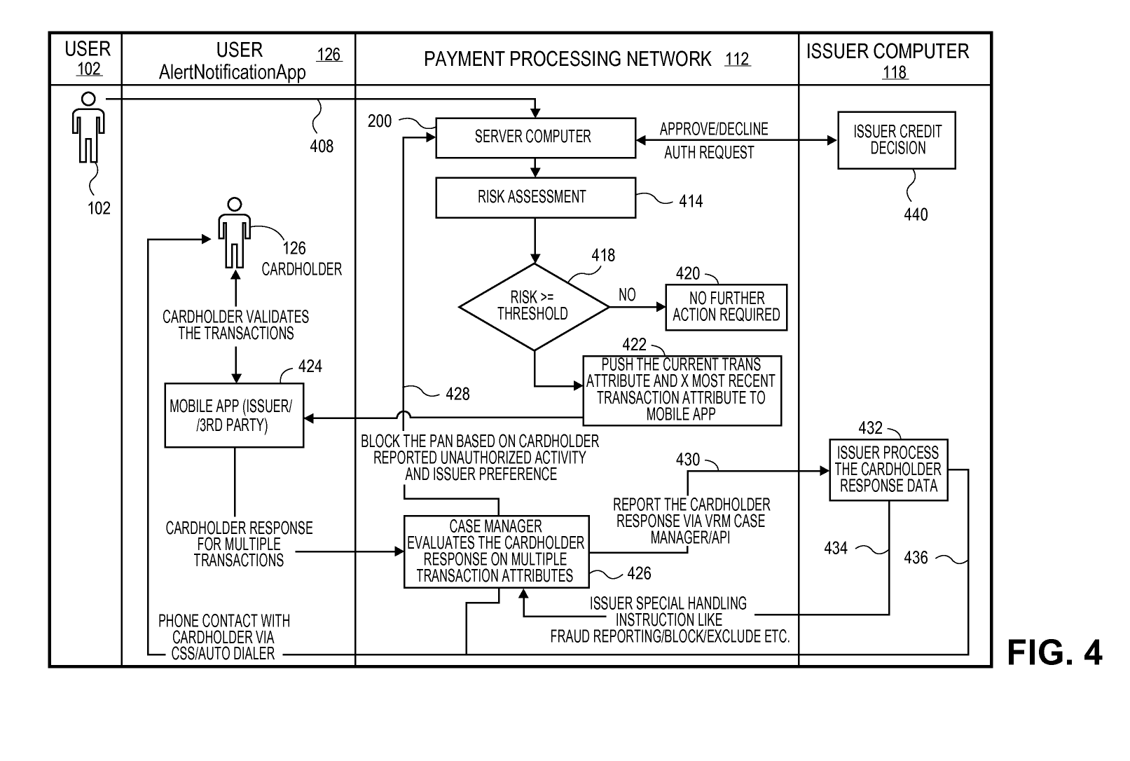

FIG. 4 shows a detailed flowchart illustrating a method according to an embodiment of the invention. In step 408, a transaction may be conducted by an unauthorized user 102 at a merchant (not shown). An authorization request message may be transmitted from the merchant's access device (see 106 in FIG. 1; not shown in FIG. 4). The authorization request message is received at a server computer 220 in a payment processing network (112 in FIG. 1).

An authorization request message may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

In step 414, a risk assessment is performed by the fraud detection module (212 in FIG. 2) in the server computer 200. The risk assessment may utilize any suitable inputs or algorithms to determine the risk of the transaction. For example, the risk assessment may take into account one or more of the following: IP address of the computer that the user is using to conduct the transaction, the transaction location, the transaction amount, the merchant, transaction velocity, past transaction history on the account, recent transaction history, etc.

In step 418, if the risk does not exceed a particular threshold, then no further action is taken with regard to alerting the cardholder 406 (step 420). The authorization request message is forwarded to the issuer computer 118 for an issuer decision before, after, or concurrently with performing the risk analysis.

If the risk is greater than the predetermined threshold (e.g., the risk score is 9 where the threshold is 7, where a higher number is more likely to be fraudulent), then in step 422, the server computer 200 using the alert generator module 214 can generate an alert message comprising information regarding the current transaction as well as a predetermined set of prior transactions. This alert message is sent to the mobile application 424 on the account holder's mobile device. The account holder 126 may interact with the mobile application 424 and the account holder 126 may provide an appropriate response indicating which, if any, of the transactions in the list are potentially fraudulent. An alert response message may then be generated by the mobile application on the mobile device and may be sent to the payment processing network (or the server computer 410).

It is noted that the receipt of the authorization request message containing the transaction data, the determination that the transaction is a high risk transaction, and the process of initiating the sending of the alert notification message may be performed in real time. Typically, at least these three steps can be performed in less than one minute.

A case manager 222 associated with the server computer 200 can then evaluate the information in the alert response message. The case manager 222 may then proceed in a number of different ways. In some embodiments, the case manager may block the authorization request message and may prevent it from being authorized if the issuer has already provided rules regarding the tolerable level of risk in the transaction. If this is the case, then an authorization response message is sent back to the merchant without contacting the issuer. In other embodiments, in step 432, the case manager 426 may send a report on the cardholder's response to the issuer computer 118. The issuer can then provide instructions to the case manager 426, which may send instructions to the server computer to block the authorization request message and send an authorization response message back to the merchant declining the transaction. Alternatively, the issuer may contact the cardholder 406 by phone to request additional authentication data (e.g., mother's maiden name), and the cardholder may provide that authentication data. If the cardholder provides the correct authentication data, then the case manager 426 may inform the server computer 200 to transmit the authorization request message to the issuer for approval (see step 440). If there is sufficient credit or funds to pay for the current transaction, then the issuer computer 118 may generate and transmit an authorization response message back to the merchant and then the cardholder via the payment processing network and an acquirer (not shown in FIG. 4).

An authorization response message may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

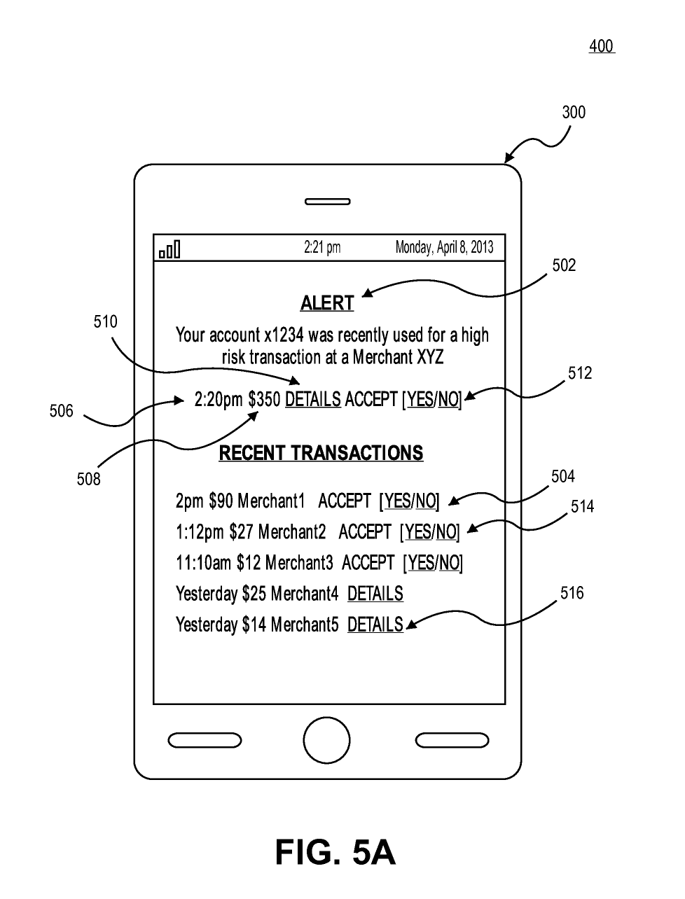

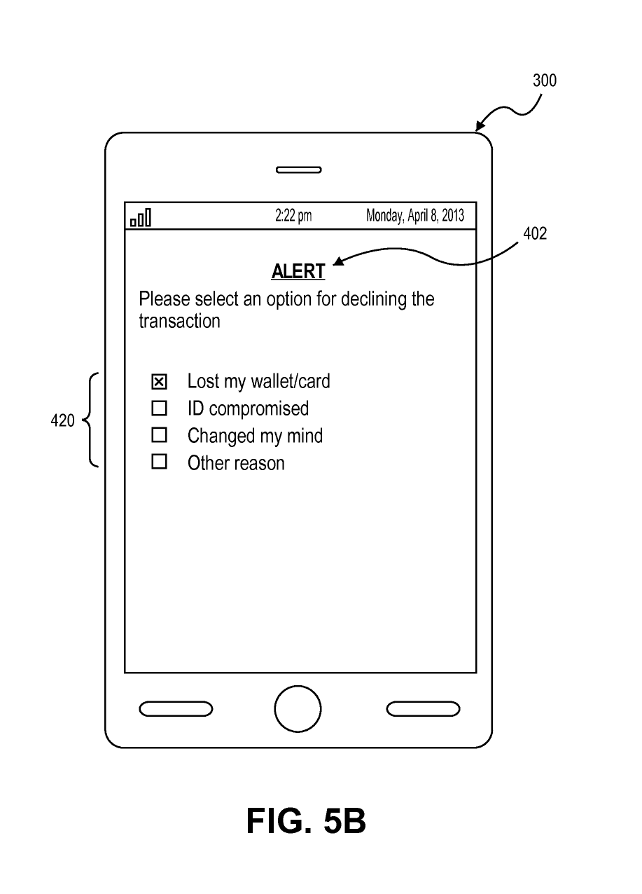

FIGS. 5A-5B illustrate exemplary alert messages received on a mobile device.

As noted above, the mobile device 124 may receive an alert message 502 when a high risk transaction is conducted by an unauthorized user (e.g., the user 102) and the account used for the transaction is registered in the high risk alert system. The alert message 502 may include a transaction time 506, a transaction amount 508, a details link 510 and an option 512 to accept or reject (YES/NO) the transaction. The details link 510 may present another screen to the user with further details relating to the transaction, e.g., product information, a merchant name, a merchant location, etc.

The alert 502 also includes details of a set of recent transactions 504 conducted on the same account. In some embodiments, the user may be presented with an option 514 to accept or reject one or more recent transactions. For example, if the clearing and settlement process has not cleared the transaction, the user has the option to reject that transaction if the transaction was not authorized by the user. In some embodiments, a set of recent transactions 516 related to the same account may be listed for reference, even though those transactions have been cleared. In some embodiments, the set of recent transactions associated with the same user and the same issuer on another account of the user may be listed for reference to monitor the activity of that account.

In one embodiment, if a transaction is rejected by the user, for example, by selecting [NO] for accepting the transaction conducted for $90 at merchant 1, another screen may be presented to the user as shown in FIG. 5B.

As illustrated in FIG. 5B, the user may be given options 520 to select for declining or rejecting the transaction. For example, the user may reject a transaction if they have lost their wallet/payment card or their ID has been compromised.

In one embodiment, the options selected by the user 526 are received by the issuer server computer 118 via the alert API module 216. The issuer server computer 118 may be able to take multiple actions on the case, including initiating an auto case close or fraud chargeback process.

Embodiments of the invention allow the issuer and the cardholder (user) participate in a targeted high risk alert system associated with a payment processing network. The issuer and the user can sign up in the alert system via the payment processing network and are alerted when a high risk transaction is conducted. The user can receive a set of recent transactions and is given an option to accept or reject each transaction using an application interface on the user mobile device. Embodiments of the invention allow an active communication between the issuer and the user. Some embodiments of the invention also reduce the cost to the issuer or the user with respect to dispute reporting and resolution.

The various participants and elements described herein with reference to FIG. 1 may operate one or more computer apparatuses to facilitate the functions described herein. Any of the elements in FIG. 1, including any servers or databases, may use any suitable number of subsystems to facilitate the functions described herein.

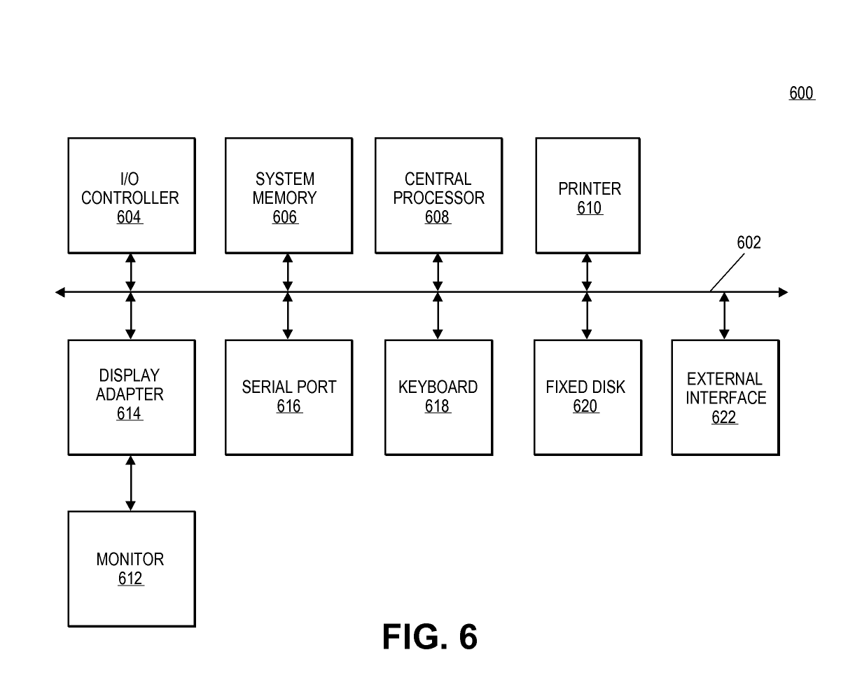

Examples of such subsystems or components are shown in FIG. 5. The subsystems shown in FIG. 6 are interconnected via a system bus 602. Additional subsystems such as a printer 610, keyboard 618, fixed disk 620 (or other memory comprising computer readable media), monitor 612, which is coupled to display adapter 614, and others are shown. Peripherals and input/output (I/O) devices, which couple to I/O controller 604 (which can be a processor or other suitable controller), can be connected to the computer system by any number of means known in the art, such as serial port 616. For example, serial port 616 or external interface 622 can be used to connect the computer apparatus to a wide area network such as the Internet, a mouse input device, or a scanner. The interconnection via system bus allows the central processor 608 to communicate with each subsystem and to control the execution of instructions from system memory 606 or the fixed disk 620, as well as the exchange of information between subsystems. The system memory 606 and/or the fixed disk 620 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving transaction data for a transaction associated with a payment account of a user;
generating, by the server computer, an alert notification message; and
initiating sending the alert notification message including information about a plurality of transactions comprising the transaction and a set of prior transactions to a mobile device.

2. The method of claim 1 wherein the set of prior transactions comprises five transactions, and wherein receiving, generating, and initiating occur in real time.

3. The method of claim 1 wherein the method comprises:
receiving an alert response message from the mobile device associated with the user in response to the alert notification message.

4. The method of claim 1 wherein the method further comprises:
determining, by a server computer, if the transaction is a high risk transaction; and
wherein generating, by the server computer, an alert notification message comprises generating, by the server computer, an alert notification message only if the transaction is a high risk transaction.

5. The method of claim 1 further comprising:
receiving an alert response message from the mobile device associated with the user in response to the alert notification message, wherein the alert response message contains data indicating which of the prior transactions are considered to be authentic by the user.

6. The method of claim 1 wherein initiating the sending of the alert notification message comprising sending, by the server computer, the alert notification message.

7. The method of claim 1 wherein the information about the transaction and the set of prior transactions comprises information regarding a transaction time and date, a transaction amount, and a merchant at which the transaction was conducted.

8. A server computer comprising:
a processor; and
a computer readable medium, wherein the computer readable medium comprise code, executable by the processor, for implementing a method comprising
receiving transaction data for a transaction associated with a payment account of a user;
generating, by the server computer, an alert notification message; and
initiating sending the alert notification message including information about a plurality of transactions comprising the transaction and a set of prior transactions to a mobile device.

9. The server computer of claim 8 wherein the method further comprises:
determining, by a server computer, if the transaction is a high risk transaction; and
wherein generating, by the server computer, an alert notification message comprises generating, by the server computer, an alert notification message only if the transaction is a high risk transaction.

10. The server computer of claim 8 wherein the method comprises:
receiving an alert response message from the mobile device associated with the user.

11. The server computer of claim 8 wherein the method comprises:
receiving an alert response message from the mobile device associated with the user in response to the alert notification message, wherein the alert response message contains data indicating which of the prior transactions are considered to be authentic by the user.

12. The server computer of claim 8 wherein the information about the transaction and the set of prior transactions comprises information regarding a transaction time and date, a transaction amount, and a merchant at which the transaction was conducted.

13. A system comprising the server computer of claim 8; and the mobile device.

14. The system of claim 13 further comprising a payment processing network configured to process credit and debit transactions, wherein the payment processing network comprises the server computer.

15. A method comprising:
receiving, from a server computer and by a mobile device operated by a user, an alert notification message, wherein the alert notification message comprises information about a plurality of transactions including a current transaction being conducted and a set of past transactions that were previously conducted using an account associated with the user; and
generating and sending, by the mobile device and to the server computer, an alert response message, wherein the alert response message comprising data indicating whether one or more of the plurality of transactions is authentic or not authentic.

16. The method of claim 15 wherein the information about the transaction and the set of prior transactions comprises information regarding a transaction time and date, a transaction amount, and a merchant at which the transaction was conducted.

17. The method of claim 15 wherein the server computer is in a payment processing network configured to perform credit and debit transactions.

18. The method of claim 17 wherein the mobile device is a mobile phone.

19. A mobile phone comprising a processor and a computer readable medium coupled to the processor, wherein the computer readable medium comprises code, executable by the processor, to perform the method of claim 17.

20. The mobile phone of claim 19 further comprising a contactless element coupled to the processor.
